(19) United States
(12) Patent Application Publication
(10) Pub. No.: US 2014/0335252 A1
(43) Pub. Date: Nov. 13, 2014

(54) ORGANIC SWEETENER

(71) Applicant: LEILA ARCIERI, WEST HOLLYWOOD, CA (US)

(72) Inventor: LEILA ARCIERI, WEST HOLLYWOOD, CA (US)

(21) Appl. No.: 14/271,898

(22) Filed: May 7, 2014

Related U.S. Application Data
(60) Provisional application No. 61/821,393, filed on May 9, 2013.

(51) Int. Cl. A23L 1/236

(52) U.S. Cl. CPC A23L 1/2363
USPC 426/548

(57) ABSTRACT

An organic sugar blend used as a sweetener substitute for sugar. The blend is a mixture of organic evaporated coconut palm sugar in the amount of at least 60% by weight mixed with Agave Inulin constituting a balance of the mixture, both the organic evaporated coconut palm sugar and the Agave Inulin being maintained at a temperature below 110 degrees Fahrenheit. The organic sugar blend would be sold in bulk containers as well as individual packets. The organic blend of the present can be used with people having Type 2 diabetes.

### CROSS REFERENCE TO RELATED APPLICATION

This application claims the benefit of U.S. Provisional Patent Application Ser. No. 61/821,393, entitled “Organic Sweetener,” filed May 9, 2013.

### BACKGROUND OF THE INVENTION

1. Field of the Invention

This invention relates to an organic sweetener to be used instead of sugar or a chemical sugar substitute.

2. Description of the Related Art

Many people have a love affair with sweet food products and beverages. If the food product is not sweet enough for a person's taste, often sugar is sprinkled over the product, such as hot and cold cereals to make the product more appealing to the taste of the user. Additionally, sugar is added to hot and cold beverages, such as tea and coffee. Unfortunately, due to its high caloric content, excessive use of sugar could result in unwanted weight gain.

Consequently, various artificial sugar substitutes have been developed, attempting to duplicate the taste of sugar as well as including fewer calories than sugar. These sugar substitutes include, for example, aspartame, sucralose and saccharin. These sugar substitutes generally include a bulking agent and often exhibit a different mouth feel and aftertaste when compared to the use of sugar. Additionally, there is an ongoing controversy over whether the use of these artificial sweeteners poses a health risk.

Alternatively, several natural sweeteners, such as Stevia have been utilized as a substitute for natural sugar. Stevia rebaudiana Bertoni is a perennial shrub of the Asieraceae (Compositae) family native to certain regions in South America and is classified as a high intensity sweetener. The leaves of this plant contain from 10% to 20% of dieterpene glycosides and are between 150 to 450 times sweeter than sugar. However, when used as a sweetener, Stevia leaves a bitter and astringent aftertaste in one's mouth, and which remains for a period of time, even after swallowing. Additionally, although Stevia is a naturally occurring sweetener, when produced, various additives are added during the manufacturing process thereby detracting from the initial natural state of Stevia.

### SUMMARY OF THE INVENTION

It is therefore an object of the present invention to overcome the deficiencies of the prior art by providing an organic substitute for sugar. The present invention employs evaporated coconut palm sugar or palm nectar, with the coconut palm sugar resulting from the evaporation of the palm nectar, and Agave Inulin as an organic sweetener. A rotary mixing device is used to mix the coconut palm sugar or nectar and the Agave Inulin for an appropriate period of time at an appropriate temperature. The organic substitute for sugar is then packaged in individual packets for distribution, or provided in bulk containers or packages for distribution to restaurants or food stores and emporiums.

It is a further object of the present invention to produce an organic sugar substitute which is easy to manufacture.

Another object of the present invention is to provide an organic low caloric sugar substitute.

Yet another object of the present invention is to produce an organic sugar substitute having a pleasant taste.

A further object of the present invention is to produce an organic sugar substitute without a bitter or astringent aftertaste.

Another object of the present invention is to provide an organic sugar substitute having a pleasant mouth feel.

Other objects and advantages of the present invention will become apparent from the following detailed description which sets forth certain embodiments of the invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make or use the invention.

The present invention provides an organic sweetener in the form of an organic sugar blend used as a substitute for natural sugar or sugar substitutes. The organic sugar blend includes pure organic evaporated coconut palm sugar combined with Agave Inulin, such as organic blue Tequilana Weber Agave Inulin. The amount of organic evaporated coconut palm sugar is at least 60% by weight of the total mixed organic sugar blend. In accordance with a preferred embodiment, the amount of the organic evaporated coconut palm sugar will be 70%-90% by weight of the total mixed organic sugar blend. With this in mind, the Agave Inulin utilized constitutes the remainder of the mixture and is no more than 40% of the total mixed organic sugar blend, preferably 10%-30% by weight of the total mixed organic sugar blend. In accordance with a preferred embodiment, the mixed organic sugar blend contains approximately 80% by weight organic evaporated coconut palm sugar and approximately 20% by weight Agave Inulin.

It is appreciated that organic evaporated coconut palm sugar is a sugar produced from the sap of cut flower buds of the coconut palm. Coconut sugar has been used as a traditional sweetener for thousands of years in the South and South-East Asian regions where the coconut palm is in abundant supply. Coconut sugar consists primarily of sucrose (containing glucose and fructose). It is appreciated the major component of coconut sugar is sucrose (70-79%) followed by glucose and fructose (constituting 3-9% each). Minor variations will occur, due to differences in primary processing, raw material source, tree age and variety of coconut. Coconut sugar has a high mineral content, and is a rich source of potassium, magnesium, zinc, and iron. In addition to this it contains Vitamin B1, B2, B3, and B6. When compared to brown sugar, coconut sugar has 18 times the potassium, 30 times the phosphorus and over 10 times the amount of zinc. The coconut sap, from which coconut sugar is derived, contains 16 amino acids. The amino acid which has the highest content in coconut sap is Glutamine.

As for Agave Inulin, it is appreciated Agave inulin is a naturally occurring polysaccharides produced by the Agave plant. Inulins belong to a class of dietary fibers known as fructans. Inulin is a heterogeneous collection of fructose polymers. Inulin consists of glucosyl moiety and fructosyl moiety, which are linked by β(2,1) bonds. The degree of polymerization of standard inulin ranges from 2 to 60. Because of the β(2,1) linkages, inulin is not digested by enzymes in the human alimentary system, contributing to its functional properties: reduced calorie value, dietary fiber and prebiotic effects.

The organic evaporated coconut palm sugar used in accordance with a preferred embodiment of the present invention is raw and has never been heated above 110 degrees Fahrenheit, resulting in the organic evaporated coconut palm sugar retaining its naturally occurring nutrients. The organic evaporated coconut palm sugar has a glycemic index of 35, thereby resulting in a minimal impact on the glucose level in the blood of an individual.

The Agave Inulin is also raw and also has a minimal impact on the glucose level in the blood of the individual. Therefore, the mixed organic sugar blend of the present invention would be suitable for an individual suffering from Type 2 diabetes and would be helpful in managing the glucose level in the blood of the individual. The present invention curbs weight gain, decreases obesity and provides a healthy manner for everyone, including diabetics, to enjoy sweetened products. Due to the fact that Agave Inulin is sugar free, the blended mixture of the present invention would have a relatively low amount of net sugar grams when the organic sugar blend of the present invention is ingested.

The organic sugar blend is produced by mixing an appropriate range of organic evaporated coconut palm sugar with an appropriate range of Agave Inulin, such as organic blue Tequilana Weber Agave Inulin in typical industrial rotary mixer used in the food industry. The amount of the two constituents in the industrial rotary mixer would be between 1 gallon and 8000 gallons. Each of the constituents, namely the evaporated coconut palm sugar and the Agave Inulin are simultaneously, or separately introduced into the rotary mixer. The interior of the mixer is kept at a temperature below 110 degrees Fahrenheit, ensuring that the organic sugar blend of the present invention remains raw and retains its nutrients. Once both of the constituents are in the mixer, the mixer is rotated, thereby producing the blended mixture. Based upon the total weight of the two constituents within the mixer, the mixing time will vary As can be appreciated, the greater the weight of the two constituents within the mixer, the greater the mixing time.

Once the rotary mixer has completed blending the two constituents together, the blended mixture constituting the present organic sugar blend would be packaged in individual serving packets or larger containers. A number of individual packets would be included within a carton which is sold to consumers or various establishments, such as grocery stores, coffee shops and restaurants. Alternatively, the blended mixture constituting the present organic sugar blend would be provided in containers similar to the cartons used to sell raw sugar, the containers including approximately 180 servings.

The evaporated coconut palm sugar exhibits a deep brown color. However, when combined with the Agave Inulin, the color of the organic sugar blend of the present invention is substantially lightened in color, changing the color to a light blond and making it more appealing to those individuals accustomed to using white sugar. The mixture of the two constituents produces a flavor that is different than each of the individual constituents when tasted alone. For example, organic evaporated coconut palm sugar has a nutty/caramel flavor, and the Agave Inulin has a citrus flavor. When blended together, the two flavors combine to create a new flavor different than the individual flavors. The flavor of present organic sugar blend is a neutral flavor not tasting like either of the two separate ingredients (that is, the organic evaporated coconut palm sugar or the Agave Inulin). Each of the flavor of organic evaporated coconut palm sugar or the flavor of the Agave Inulin effectively cancels the flavor of the other creating a pleasing taste that is more consist with the neutral taste of regular table sugar making it the perfect sugar replacement in any recipe. Ultimately, this new flavor is neutral and lighter than the flavor of light brown sugar.

Additionally, the Agave Inulin acts as a wick and attracts moisture. Therefore, when the organic sugar blend of the present invention is used for baking, the baked items resist drying out as well as crumbling.

In fact, and during development and testing of the present organic sugar blend, it was discovered that one can replace sugar 1:1 in any recipe and baked goods stayed moist even when left uncovered/unprotected/unrefrigerated. Still further, head to head taste offs between items baked with regular sugar and items baked with the present organic sugar blend, found that the present organic sugar blend was preferred every time. Testers felt their sweet tooth/craving was satiated faster while eating much less of the treat; resulting in testers eating less of the treat (less calories) but feeling more satisfied. Plus, the tasters felt less guilt knowing that the treat is low glycemic and contains more nutrients.

The amount of organic sugar blend of the present invention having a serving size of one teaspoon (five (5) grams) includes zero (0) grams of total fat, zero (0) milligrams of cholesterol, eight (8) milligrams of sodium, fifty-four (54) milligrams of potassium, five (5) grams of total carbohydrates consisting of four (4) grams of sugar and one (1) gram of dietary fiber. The single teaspoon of the organic sugar blend also has only 18 calories and zero grams of protein. The amount of potassium amounts to 2% of the individual's daily value and the total carbohydrates amounts to 2% of the individual's daily values, the daily values based upon a 2,000 calorie diet.

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

While the preferred embodiments have been shown and described, it will be understood that there is no intent to limit the invention by such disclosure, but rather, is intended to cover all modifications and alternate constructions falling within the spirit and scope of the invention.

1. An organic sweetener, comprising:
a mixture of organic evaporated coconut palm sugar in the amount of at least 60% by weight mixed with Agave Inulin constituting a balance of the mixture, both the organic evaporated coconut palm sugar and the Agave Inulin being maintained at a temperature below 110 degrees Fahrenheit.

2. The organic sweetener according to claim 1, wherein the Agave Inulin is organic blue Tequilana Weber Agave Inulin.

3. The organic sweetener according to claim 1, wherein the sweetener includes organic evaporated coconut palm sugar in the amount of approximately 80% by weight and Agave Inulin in the amount of approximately 20% by weight.

4. The organic sweetener according to claim 1, wherein the organic evaporated coconut palm sugar has a glycemic index of 35.

5. The organic sweetener according to claim 1, wherein the Agave Inulin substantially lightens a deep brown color exhibited by the organic evaporated coconut palm sugar.

6. A method for making an organic sweetener, comprising:
mixing organic evaporated coconut palm sugar in the amount of at least 60% by weight with Agave Inulin constituting a balance of the mixture; and
maintaining the mixture at a temperature below 110 degrees Fahrenheit.

7. The method according to claim 6, wherein the Agave Inulin is organic blue Tequilana Weber Agave Inulin.

8. The method according to claim 6, wherein the sweetener includes organic evaporated coconut palm sugar in the amount of approximately 80% by weight and Agave Inulin in the amount of approximately 20% by weight.

9. The method according to claim 6, wherein the organic evaporated coconut palm sugar has a glycemic index of 35.

10. The method according to claim 1, wherein mixing of the Agave Inulin with the organic evaporated coconut palm sugar substantially lightens a deep brown color exhibited by the organic evaporated coconut palm sugar.
